(19) United States
(12) Patent Application Publication
(10) Pub. No.: US 2002/0193117 A1
(43) Pub. Date: Dec. 19, 2002

(54) Call reservation for wireless systems

(76) Inventors: Stephen C. Goss, Wheaton, IL (US); George Jay Hruska, Naperville, IL (US); Jeffrey Ross Light, Lincolnwood, IL (US); Chung-Zin Liu, Naperville, IL (US); Omar Hernando Salvador, Wheaton, IL (US); Gitesh P. Shah, Naperville, IL (US); Mark Kevin Stockert, Singapore (SG); Charles Varvaro, Glendale Heights, IL (US); Randall Joe Wilson, Naperville, IL (US)

Correspondence Address: Werner Ulrich, 434 Maple Street, Glen Ellun, IL, 60137-3826, US

(21) Appl. No.: 09/882,586

(22) Filed: Jun. 14, 2001

(51) Int. Cl. H04Q 7/20

(52) U.S. Cl. 455/452; 455/455; 455/514

(57) ABSTRACT

A method and apparatus for establishing a wireless telephone connection when a call cannot be made immediately. The caller and the wireless system negotiate for a later time when another attempt will be made to establish the call. Shortly before that time arrives, the wireless system reserves a radio channel and retains that channel for the deferred call. Then, the system calls the customer back, or waits for the customer to attempt the call. A reserved channel is then used for the call if the system has been successful in reserving such a channel. Advantageously, there is a high probability that the deferred call will have a radio channel available.

### TECHNICAL FIELD

This invention relates to establishment of calls in wireless telecommunications systems.

Problem

Wireless telecommunications systems require the use of a radio link to connect a caller or a called party to a telecommunications network for interconnecting the wireless station with the other end of the connection. Radio channels in wireless systems are scarce resources which are often not available for originating a call. When this happens, the caller tries again. If the system is overloaded, there is a good chance that the caller will again be denied service for lack of a radio channel. This situation is frustrating to the caller, and makes inefficient use of the control channel and control processor resources of the wireless telecommunications system serving the caller. The problem is especially serious for service provider who frequently block calls because of unavailable channels. A problem of the prior art is that there is not a good way of serving wireless callers when the number of radio channels available is temporarily inadequate.

Solution

The above problem is substantially alleviated in accordance with Applicants' invention, wherein if a caller can not access the wireless network because no radio communications channel is available, the caller is assigned a time when the system will try again to complete a call for that caller. Advantageously, by properly selecting this assigned time, there is a good chance that the call will go through.

In accordance with one feature of Applicants' invention, the telecommunications system attempts to reserve a radio channel for the caller prior to the time that the caller is contacted, in order to try to complete the call. Advantageously, this increases the likelihood that at the assigned time, the call can be completed.

In accordance with another feature of Applicants' invention, the caller and the system together negotiate a time that is satisfactory to the caller and that the system predicts that there is a good likelihood of a radio channel being available. Advantageously, the caller's demands can be met, and the probability that the call can be completed can be increased. Advantageously, the caller is discouraged from using repeated attempts, which consume system resources, in order to complete the call.

In accordance with another feature of Applicants' invention, if the caller so indicates, the system records the called number and can then try to establish the call at the assigned time, advantageously, without requiring the caller to re-dial the called number.

In one preferred embodiment of Applicants' invention, starting at “P” seconds before the assigned time, the system will attempt to reserve a radio communications channel for the caller. “P” is a parameter assigned by the carrier on the basis of policy and field experience. Advantageously, this increases the likelihood that the channel will be available for the caller at the assigned time.

### BRIEF DESCRIPTION OF THE DRAWINGS(s)

FIG. 1 is a block diagram illustrating a mobile station cell site and mobile switching center of a mobile telecommunications system;

FIGS. 2-4 are flow diagrams illustrating the operation of Applicants' invention.

### DETAILED DESCRIPTION

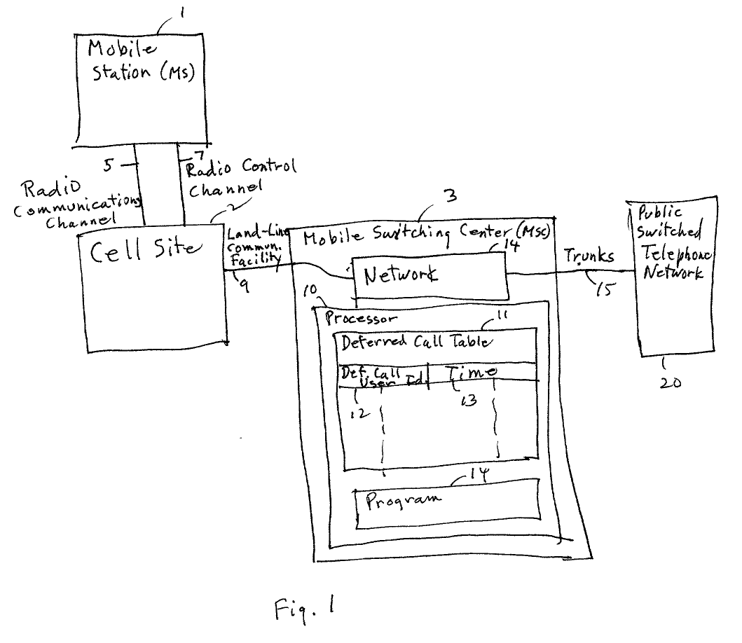

FIG. 1 is a block diagram illustrating the key elements of a mobile telecommunications system. Mobile Station (1) is the mobile station of the user who is attempting to place a wireless call. The mobile station is connected to a Cell Site (2), serving mobile stations in the cellular area controlled by that cell site. The mobile station is connected to the cell site by a Radio Control Channel (7), and a plurality of Radio Communication Channels (5), each channel being used for one communication. If all channels are being used for communications with other mobile stations, then the caller receives a signal over the radio control channel that no radio communications channels are available for a call. The cell site is connected, usually by a Land-Line Facility (9) to a Mobile Switching Center (MSC) (3), which is connected by a Group of Trunks (15) to the Public Switched Telephone Network (PSTN) (20) for accessing a called station. Channels on the Land-Line Communication Facility (9) are connected through Switching Network (14) of MSC (3) to Trunks (15) for connection to the Public Switched Telephone Network (PSTN) (20). Switching Network (14) is controlled by a Processor (10), which operates under the control of a Program (14) stored therein.

In accordance with Applicants' invention, the Processor also contains a Deferred Call Table (11) for storing information about deferred calls. A typical entry contains a Deferred Call User Identification (12) for identifying the caller associated with a particular deferred call, and a Time (13) that has been assigned to that deferred call.

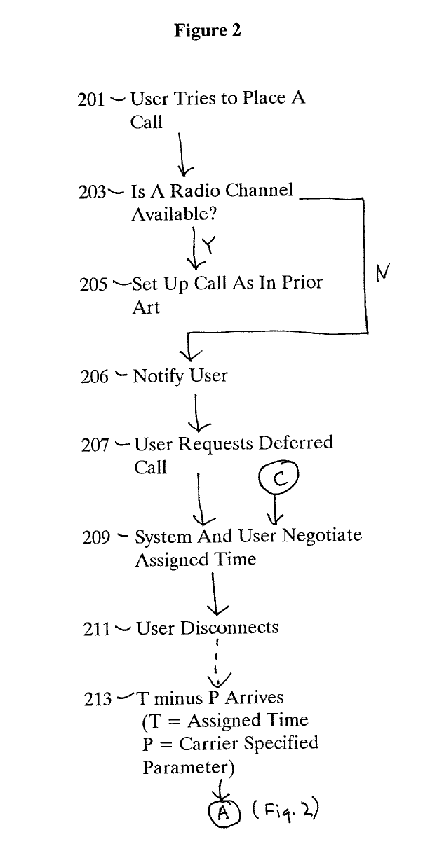

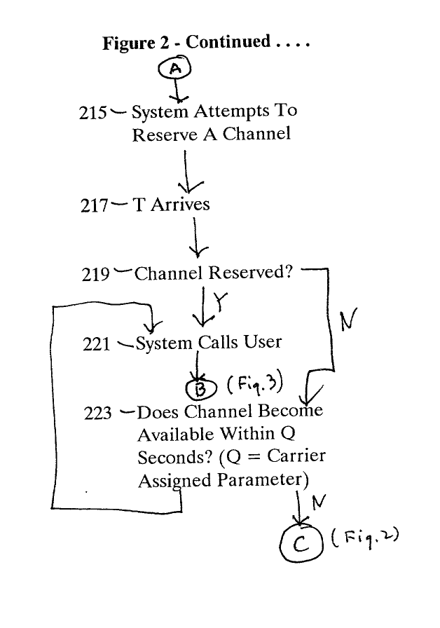

FIGS. 2-4 are flow charts illustrating the operation of Applicants' invention. Most of the blocks on the Flow Chart, i.e., all except those referring to user actions, are actions executed by the Processor under the control of Program (14).

The process starts when the user tries to place a wireless call, Action Block (201). Test (203) determines whether a radio channel is available. If a radio channel is available, then the call is set up as in the prior art, Action Block (205). If no radio channel is available, the user is notified, Action Block (206). The user is notified by means of a message sent over the control channel; this message does not require the use of an unavailable radio communications channel. If, in response to this notification, the user requests a deferred call, Action Block (207), (as opposed to simply disconnecting), then, the system and the user negotiate an assigned time, Action Block (209). The system may utilize statistics as to the relative business of various times, and the user may set a limit as to the maximum amount of time that the user is willing to wait. The negotiated time can be set by communications between the user and the system over the radio control channel; the user can specify a numerical time using the digits on the mobile station. The system will limit the number of channels reserved for deferred calls at any one time, based on policy and field experience. A negotiation can work as follows: The system provides an initial recommendation for an assigned time; the user responds with an acceptance or a suggested later time; the system assigns a time based on this suggested time, but varied randomly over a pre-defined interval about that suggested time, and reports this suggested time to the user. The negotiations and notification can be conducted using Short Message Service or other display system, which uses the control channel and does not require the availability of a traffic channel, or using one or more tones triggered by a control message. After an assigned time has been agreed upon, the user disconnects, Action Block (211). After a further interval, the assigned time, less an interval P, arrives, Action Block (213). The interval P might, for example, be 10 seconds, to give the system a reasonable probability of detecting a disconnect if, at the beginning of the interval, all channels are busy. The size of P is determined by the carrier operating the wireless telecommunication system. Throughout this interval P, the system attempts to reserve a radio channel. In order to do so, the system pages the mobile station in order to locate that station and identify the radio channels that can now serve that station, Action Block (215). The assigned Time arrives, Action Block (217). Test (219) determines whether a radio channel has been reserved for the deferred call. If not, then the system attempts for an additional interval “Q”, also determined by the controlling carrier, to reserve a radio channel. Test (223) determines whether or not a radio channel has become available in that interval. If no radio channel has become available during that interval, the caller is called back, Action Block (206), and if the user so requests, Action Block (207), Action Block (209) is used to negotiate a new assigned Time. This time is re-entered, and the actions of Action Blocks (211), (213), (215), (217), and Test (219) are repeated. If a reserved channel is available as detected in Test (219) or Test (223), then the system calls the user, Action Block (221).

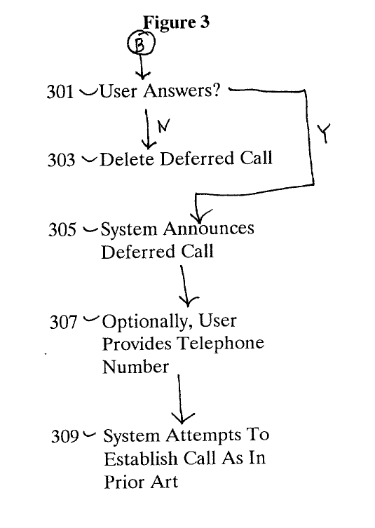

The flow is continued on FIG. 3, with Test (301) to determine whether the user answers. If the user does not answer, the deferred call is deleted from the system, Action Block (303). If the user does answer, the system announces the deferred call to the user, Action Block (305). If the system has not saved the called number, then the user provides the called telephone number, Action Block (307). Subsequently, the system attempts to establish the deferred call as in the prior art, Action Block (309).

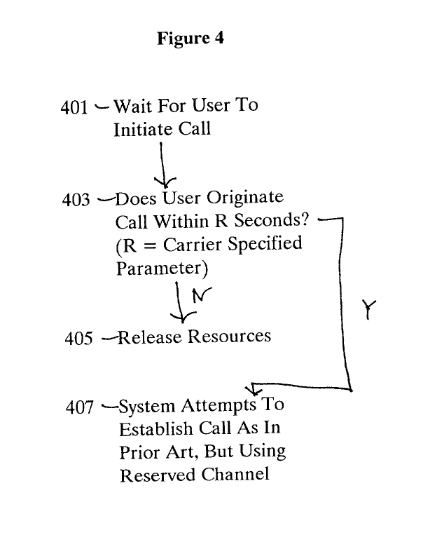

FIG. 4 is a flow diagram illustrating an alternate approach to establishing the deferred call once a channel has become available, and has been detected as a positive result of Test (219) or Test (223). In accordance with this alternate process, the system waits for the user to initiate the call at the assigned time, Action Block (401). Test (403) is used to determine whether the user has initiated a call within “R” seconds. Again, “R” is a parameter selected by the operating carrier. If not, then the system releases the reserved channel resources, Action Block (405). If the user does initiate the call, then the system will attempt to establish the call as in the prior art, but using the reserved radio communications channel, Action Block (407).

The above description is of one preferred embodiment of Applicants' invention. Other embodiments will be apparent to those of ordinary skill in the art without departing from the scope of the invention. The invention is limited only by the attached Claims.

1. A method of establishing a wireless cellular telecommunications call, comprising the steps of:
originating said call;
if a radio channel is available for said call, establishing said call in accordance with the principles of the prior art;
if no radio channel is available for said call, deferring establishment of said call to an assigned time; and
establishing said call at said assigned time.

2. The method of claim 1, wherein the step of deferring establishment of said call comprises the steps of:
notifying said user that no radio channel is available; and
receiving a deferred call request from said user.

3. The method of claim 2, wherein the step of deferring establishment of said call comprises the step of negotiating said assigned time between said user and the telecommunications system.

4. The method of claim 1, wherein the step of establishing said call at said assigned time, comprises the step of reserving a channel at said assigned time, and calling said user to inform said user that said call can now be attempted.

5. The method of claim 4, wherein the step of receiving a channel comprises the step of paging said user in order to locate said user.

6. The method of claim 4, wherein the step of reserving a channel for said call comprises the step of attempting to reserve a channel for said call for a period of P seconds prior to said assigned time, wherein P is a parameter determined by an operator of said mobile telecommunications system.

7. The method of claim 1, wherein the step of attempting to complete said call at said assigned time comprises the steps of:
reserving a channel for use by said user at said assigned time;
said system waiting for said user to originate said call;
if said user originates said call within R seconds, completing said call as in the prior art; and
if said user does not attempt to originate said call within R seconds, releasing resources reserved for said call.

8. The method of claim 7, wherein the step of reserving a channel comprises the step of paging said user in order to locate said user.

9. Apparatus for establishing a wireless cellular telecommunications call, comprising:
processor means for controlling the following steps:
responsive to receipt of an origination request for a call from a mobile station, determining whether a radio channel is available for said call;
if a radio channel is available for said call, establishing said call in accordance with the principles of the prior art;
if no radio channel is available for said call, deferring establishment of said call to an assigned time; and
establishing said call at said assigned time.

10. The apparatus of claim 9, wherein the step of deferring establishment of said call comprises the steps of:
notifying said user that no radio channels are available; and
receiving a deferred call request from said user.

11. The apparatus of claim 10, wherein the step of deferring establishment of said call, comprises the step of controlling negotiations for said assigned time between said user and the telecommunications system.

12. The apparatus of claim 9, wherein the step of establishing said call at said assigned time, comprises the step of reserving a channel at said assigned time, and calling said user to inform said user that said call can now be attempted.

13. The apparatus of claim 9, wherein the step of reserving a channel comprises the step of paging said user in order to locate said user.

14. The apparatus of claim 12, wherein the step of reserving a channel for said call comprises the step of attempting to reserve a channel for said call for a period of P seconds prior to said assigned time, wherein P is a parameter determined by an operator of said mobile telecommunications system.

15. The apparatus of claim 9, wherein the step of attempting to complete said call at said assigned time comprises the steps of:
reserving a channel for use by said user at said assigned time;
said system waiting for said user to originate said call;
if said user originates said call within R seconds, completing said call as in the prior art; and
if said user does not attempt to originate said call within R seconds, releasing resources reserved for said call.

16. The apparatus of claim 15, wherein the step of receiving a channel comprises the step of paging said user in order to locate said user.
